(19) United States
(12) Patent Application Publication
(10) Pub. No.: US 2007/0257410 A1
(43) Pub. Date: Nov. 8, 2007

(54) External shock absorber

(75) Inventors: Michael JC Toh, Singapore (SG); Jui Jing Lim, Singapore (SG); ChoonKiat Lim, Singapore (SG); Xiong Liu, Singapore (SG)

Correspondence Address: SHUMAKER & SIEFFERT, P. A., 1625 RADIO DRIVE, SUITE 300, WOODBURY, MN, 55125, US

(73) Assignee: Seagate Technology LLC, Scotts Valley, CA (US)

(21) Appl. No.: 11/418,444

(22) Filed: May 4, 2006

(51) Int. Cl. F16F 1/36

(52) U.S. Cl. 267/153

(57) ABSTRACT

Embodiments of the invention are directed to an external shock absorber for an electronic device such as a disc drive. The external shock absorber is made from an elastomeric material with an arrangement of foam-like internal and external cavities. The external shock absorber may be placed adjacent to a housing of an electronic device to provide shock absorption, may cover a portion of the electronic device housing, or may be shaped to cover a portion of the electronic device housing.

### TECHNICAL FIELD

The invention relates to external shock absorbers for electronic devices.

### BACKGROUND

Portable electronic devices, such as portable disc drives and consumer devices incorporating small form factor disc drives, experience mild shocks through everyday use. For example, setting a portable electronic device on a table causes a mild shock. Simply pressing buttons on a portable electronic device also causes repeated mild shocks. In addition, portable electronic devices are often mishandled. For example, portable electronic devices may be accidentally dropped, stuck in the bottom of a backpack under a pile of books or otherwise subjected to significant shocks.

These shocks can cause damage to portable electronic devices either immediately or though the combined effect of repeated shocks. For example, with respect to portable disc drives and consumer devices incorporating small form factor disc drives, external shocks can cause a read head to contact the data storage media. This can scratch the media causing a portion of the media to be unusable. It is also possible for read heads themselves to be damaged, which may result in complete data loss. Other damage may also occur, such as damage to the spindle motor, bearings or electronics within a disc drive.

To counteract effects of external shocks, many electronic devices include an external shock absorber. Currently existing shock absorbers are typically made of elastomeric materials, such as rubber. These materials are selected because they are durable and able to withstand many shock impacts without deteriorating.

### SUMMARY

While deformable, elastomers are substantially incompressible. They deflect by changing shape rather than changing volume. Therefore, an elastomer may have low maximum deflection and similar dynamic and static stiffness. Solid elastomeric shock absorbers may bottom-out when subject to a relatively high-impact shock, which can exacerbate shock amplitudes. Foams provide higher dynamic stiffness than static stiffness, which may prevent bottoming-out under high-velocity shocks. However, foams are generally prone to wear and tear and may crumble or otherwise deteriorate if used as an external shock absorber.

In one embodiment, this disclosure is directed to an assembly comprising an electronic device including an electronic device housing and an external shock absorber adjacent the electronic device housing, wherein the external shock absorber comprises an elastomer with an arrangement of internal cavities.

In another embodiment, the invention is directed to a method comprising injecting a supercritical fluid into a liquid elastomer to form a single-phase solution, injecting the single-phase solution into a mold shaped as an external shock absorber for an electronic device, at least partially curing the single-phase solution under conditions such that a sufficient amount of the supercritical fluid is removed from the solution to form an arrangement of internal cavities therein and removing the single-phase solution from the mold to form the external shock absorber.

In a different embodiment, this disclosure is directed to an assembly comprising an electronic device including an electronic device housing, and a means for absorbing an external shock to the electronic device wherein the means for absorbing the external shock provides a greater dynamic stiffness than static stiffness.

External shock absorbers as described herein may provide durability similar to solid elastomer shock absorbers, but also provides better shock absorption with a low coefficient of restitution and a higher dynamic stiffness than static stiffness. The cavities may also provide increased compressibility to the external shock absorber, which may allow the external shock absorber to absorb shocks without bottoming out.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIGS. 1A-1B are illustrations of an electronic device with an external shock absorber having internal cavities.

FIG. 2 is a flowchart illustrating techniques for producing an elastomer external shock absorber having internal cavities.

FIG. 3 is a flowchart illustrating techniques for producing an elastomer external shock absorber overmold having internal cavities.

### DETAILED DESCRIPTION

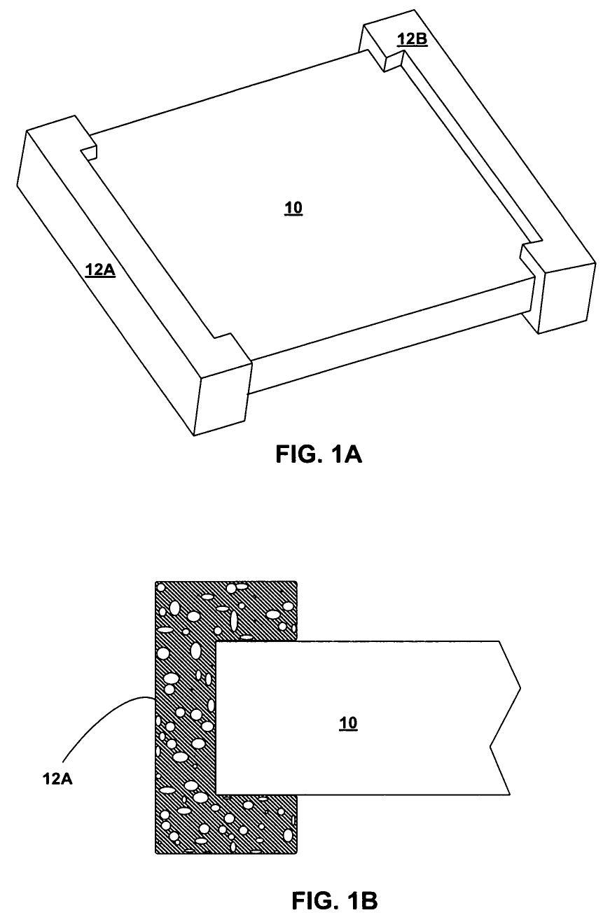

FIGS. 1A-1B are illustrations of electronic device 10 with external shock absorbers 12A and 12B (external shock absorbers 12). FIG. 1A illustrates a broad plan view of device 10 with external shock absorbers 12, while FIG. 1B illustrates a close-up cross-sectional view of device 10 and external shock absorber 12A.

Electronic device 10 includes a housing that encases components of electronic device 10. For example, electronic device 10 may be a small form factor disc drive. Furthermore, electronic device 10 may be a component of a larger electronic device, such as a portable electronic device. For example, electronic device 10 may be a component of a laptop computer, a digital music player or a cellular phone. As such, electronic device 10 and external shock absorbers 12 may be mounted within a housing of a larger electronic device. In some embodiments, electronic device 10 may be mounted within the larger electronic device only through external shock absorbers 12 in order to provide shock protection for electronic device 10 relative to the motion of the larger electronic device. In other embodiments, electronic device 10 may operate as a stand-alone electronic device.

External shock absorbers 12 are made from an elastomeric material, which generally refers to natural rubbers or synthetic thermosetting polymers having properties similar to those of vulcanized natural rubber. The elastomer material or materials may vary widely depending on the intended application, but in general are selected to provide excellent durability and good shock absorption qualities. The external shock absorbers 12 may be made from a variety of elastomeric materials including, for example, natural rubbers, polyvinyl chlorides (PVC), poloyolefin synthetic rubbers such as butyl rubber, ethylene propylene diene monomer (EPDM), styrene-butadiene rubbers, neoprene rubbers, nitrile rubbers, isoprene rubbers, polysulfide rubbers, chloroprenes, propylene, urethane rubbers, silicone rubbers and combinations thereof. These materials may be crosslinked or uncrosslinked. Other rubber-like materials such as, for example, uncrosslinked thermoplastics like TPO rubbers, may also be used.

As shown in FIG. 1B with respect to external shock absorber 12A, external shock absorbers 12 include an arrangement of cavities. The arrangement of cavities may include internal cavities and some external cavities. The internal cavities are labeled as internal because each individual internal cavity does not reach an external surface of external shock absorbers 12. Some or all of the internal cavities may indirectly connect to an external surface of external shock absorbers 12.

The internal and external cavities within external shock absorbers 12 make external shock absorbers 12 compressible in part because air within the cavities is compressible. While not wishing to be bound by any particular theory, in embodiments where some or all of the internal cavities connect to an external surface of external shock absorbers 12, those internal cavities give external shock absorbers 12 a greater dynamic stiffness than static stiffness because it is difficult for air within cavities to flow out of external shock absorbers 12. This strain rate-sensitive stiffness reduces the chance that external shock absorbers 12 will bottom out in response to a shock. Bottoming out could exacerbate the shock amplitude and cause damage to internal components of electronic device 10.

The concentration, size and shape of the internal and external cavities in external shock absorbers 12 may vary widely depending on the intended application and the elastomeric material selected. In some embodiments, the internal and external cavities may make up between twenty and sixty percent by volume of the total volume of external shock absorbers 12. For example, the internal and external cavities may make up thirty to forty percent by volume of the total volume of external shock absorbers 12. The shape of the cavities may also vary widely, but typically the cavities will have a substantially circular cross sectional shape. In some embodiments, the average diameter of the cavities is between 0.05 and 0.2 millimeters. For example, the average diameter of the cavities may be between 0.08 and 0.15 millimeters.

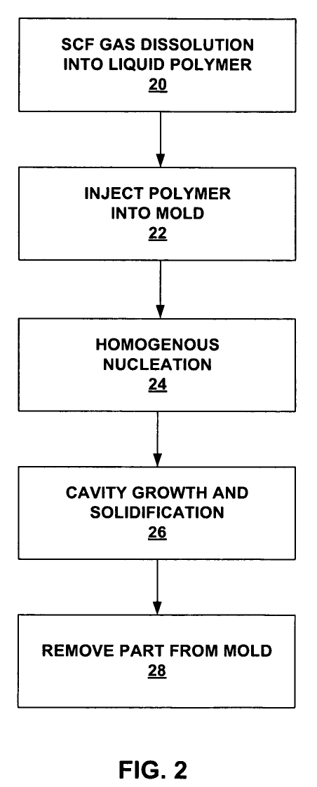

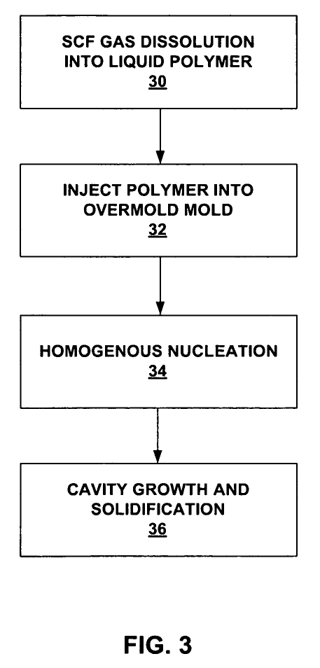

The external shock absorbers 12A and 12B may be free standing and placed adjacent to the housing 10 of an electronic device, or may cover a portion of an electronic device housing 10. In addition, as described with respect to FIGS. 2 and 3 respectively, shock absorbers 12 can be molded as separate parts that are later attached to electronic device 10 or overmolded directly on electronic device 10. A first elastomeric material with a selected cavity shape and/or volume may be used to protect a first portion of an electronic device, and the cavity shape and/or volume may be changed to protect a second portion of the device different from the first portion. In the alternative, a second elastomeric material with the same or a different cavity shape and/or volume may be used to protect the second portion of the device.

FIG. 2 is a flowchart illustrating exemplary techniques for producing an external shock absorber including an elastomeric material with internal and optional external cavities. For example, techniques for producing an elastomer external shock absorber may be similar to conventional techniques of microcellular foam molding or structural foam molding. The described techniques for producing an external shock absorber may be used to form external shock absorbers 12.

First, a supercritical fluid is dissolved into a fluid elastomer to form a single-phase solution (20). For example, the supercritical fluid may be an atmospheric gas such as carbon dioxide or nitrogen. Then the single-phase solution is injected into a mold having the shape of the external shock absorber (22). As an alternative embodiment, a supercritical fluid may be injected into a mold already containing a fluid elastomer in order to form a single-phase solution within the mold.

After the supercritical fluid is dissolved into a fluid elastomer, a large number of nucleation sites form within the mold as the supercritical fluid begins to diffuse out of the solution and vaporize. The nucleation sites provide locations for internal and external cavities to grow. The nucleation sites may be approximately homogeneous within the mold (24).

The cavities grow in size as the supercritical fluid continues to vaporize. For example, the average cavity may grow to a size between 0.05 and 0.2 millimeters. For example, the average cavity may grow to a size between 0.08 and 0.15 millimeters. The fluid elastomer solidifies and at least partially cures as the cavities form their final sizes (26). If the solidification is not properly balanced with the cavity growth, the cavities may be concentrated in the upper portion of the mold. Solidification may be controlled with temperature variations and cavity growth may be controlled with pressure and temperature. Using pressure and temperature variations, the approximate size of cavities may also be controlled. In a completed external shock absorber, the cavities may form between twenty and sixty percent by volume of the completed external shock absorber. For example, the cavities may form between thirty and forty percent by volume of the completed external shock absorber. Other embodiments may include a different concentration of cavities.

The shape of the mold determines the final shape of the external shock absorber. Thus, the now-solid external shock absorber can be removed from the mold and mounted on an electronic device housing (28). For example, the external shock absorber may be glued, press-fit or otherwise attached to an electronic device housing. In other embodiments, additional shaping of the external shock absorber may occur after removing the part from the mold, by cutting away excess material for example.

FIG. 3 is a flowchart illustrating techniques for producing an external shock absorber overmold on an electronic device. For example, techniques for producing an elastomer external shock absorber may be similar to conventional techniques of microcellular foam molding or structural foam molding. The described techniques for producing an external shock absorber may be used to form external shock absorbers 12. The techniques shown in FIG. 3 are substantially similar to the techniques shown in FIG. 2 with the exception that the external shock absorber is produced as an overmold directly on the surface of a housing of an electronic device. For brevity, some details described with respect to FIG. 2 are not discussed with respect to FIG. 3. As compared to the techniques of FIG. 2, the techniques of FIG. 3 may reduce manufacturing costs because the additional process step of attaching the molded external shock absorber to an electronic device housing is not required.

First, a supercritical fluid (SCF) is dissolved into a fluid elastomer to form a single-phase solution (30). For example, the SCF may be an atmospheric gas such as carbon dioxide or nitrogen. The single-phase solution is injected into an overmold (32). The overmold includes a portion of the electronic device housing that will be covered by the external shock absorber and otherwise forms the shape of the external shock absorber. As an alternative, an SCF may be injected into an overmold already containing a fluid elastomer.

After the SCF is dissolved into the fluid elastomer, a large number of nucleation sites form within the mold as the SCF begins to diffuse out of the solution and vaporize. The nucleation sites provide locations for internal and external cavities to grow. The nucleation sites may be approximately homogeneous within the overmold (34).

The cavities grow in size as the SCF continues to diffuse out of solution and vaporize. In some embodiments, the average cavity may grow to a size between 0.05 and 0.2 millimeters. For example, the average cavity may grow to a size between 0.08 and 0.15 millimeters. The fluid elastomer solidifies and at least partially cures as the cavities form their final sizes (36). If the solidification is not properly balanced with the cavity growth, the cavities may be concentrated in the upper portion of the mold. The solidification and cavity growth may be controlled as described with respect to FIG. 2. The cavities may form between twenty and sixty percent by volume of the completed external shock absorber. For example, the cavities may form between thirty and forty percent by volume of the completed external shock absorber.

Because the mold includes the portion of the electronic device housing that contacts the external shock absorber, the external shock absorber does not need to be separately attached to the electronic device housing. However, in some embodiments, an adhesive may optionally be placed between the electronic device housing and the external shock absorber prior to injecting the fluid elastomer into the mold. The adhesive may ensure that the overmolded external shock absorber remains in place.

Various embodiments of the invention have been described. However, modifications can be made to the described embodiments without departing from the spirit and scope of the invention. For example, an electronic device is generally shown with two external shock absorbers: one on each end of the electronic device. In other embodiments, more than two external shock absorbers or even a single external shock absorber may be used to protect all or a portion of an electronic device.

These and other embodiments are within the scope of the following claims.

1. An assembly comprising:
an electronic device including an electronic device housing; and
an external shock absorber adjacent the electronic device housing, wherein the external shock absorber comprises an elastomer with an arrangement of internal cavities.

2. The assembly of claim 1, wherein the shock absorber covers at least a portion of the electronic device housing.

3. The assembly of claim 1, wherein the assembly comprises a first external shock absorber comprising a first elastomer on a first portion of the housing, and a second external shock absorber comprising a second elastomer on a second portion of the housing different from the first portion.

4. The assembly of claim 1, wherein the external shock absorber is an overmold on the electronic device housing.

5. The assembly of claim 1, wherein the internal cavities have an average diameter between 0.05 and 0.2 millimeters.

6. The assembly of claim 5, wherein the internal cavities have an average diameter between 0.08 and 0.15 millimeters.

7. The assembly of claim 1, wherein the internal cavities make up between thirty and forty percent by volume of the total volume of the external shock absorber.

8. The assembly of claim 1, further comprising an adhesive between the electronic device housing and the external shock absorber.

9. The assembly of claim 1, wherein the elastomer is selected from the group consisting of natural rubbers, polyvinyl chlorides (PVC), poloyolefin synthetic rubbers, ethylene propylene diene monomer (EPDM), styrene-butadiene rubbers, neoprene rubbers, nitrile rubbers, isoprene rubbers, polysulfide rubbers, chloroprenes, propylene, urethane rubbers, silicone rubbers and combinations thereof.

10. The assembly of claim 9, wherein the elastomer is ethylene propylene diene monomer.

11. The assembly of claim 1, wherein the electronic device is a disc drive.

12. A method comprising:
injecting a supercritical fluid into a liquid elastomer to form a single-phase solution;
injecting the single-phase solution into a mold shaped as an external shock absorber for an electronic device;
at least partially curing the single-phase solution under conditions such that a sufficient amount of the supercritical fluid is removed from the solution to form an arrangement of internal cavities therein; and
removing the single-phase solution from the mold to form the external shock absorber.

13. The method of claim 12, wherein the internal cavities have an average diameter between 0.05 and 0.2 millimeters.

14. The method of claim 12, wherein the internal cavities make up between twenty and sixty percent by volume of the total volume of the external shock absorber.

15. The method of claim 12, wherein the liquid elastomer is ethylene propylene diene monomer.

16. The method of claim 12, wherein the mold includes the electronic device such that the external shock absorber is an overmold on a housing of the electronic device.

17. The method of claim 12, wherein the supercritical fluid comprises nitrogen.

18. The method of claim 12, wherein the electronic device is a disc drive.

19. An assembly comprising:
an electronic device including an electronic device housing; and
a means for absorbing an external shock to the electronic device wherein the means for absorbing the external shock provides a greater dynamic stiffness than static stiffness.

20. The assembly of claim 19, wherein the electronic device is a disc drive.
